(19) United States
(12) Patent Application Publication
(10) Pub. No.: US 2007/0070220 A1
(43) Pub. Date: Mar. 29, 2007

(54) Method and camera for image enhancement

(76) Inventors: Jean-Marie Vau, Paris (FR); Nicolas P. Touchard, Suresnes (FR); Olivier A. Furon, Dinard (FR)

Correspondence Address: PATENT LEGAL STAFF, EASTMAN KODAK COMPANY, 343 STATE STREET, ROCHESTER, NY, 14650-2201, US

(21) Appl. No.: 10/596,383

(22) PCT Filed: Nov. 26, 2004
(86) PCT No.: PCT/EP04/13404

§ 371 Date: Jun. 12, 2006

(30) Foreign Application Priority Data
Dec. 12, 2003 (FR) 03/14545

(51) Int. Cl. H04N 5/262

(52) U.S. Cl. 348/239

(57) ABSTRACT

The invention relates to a camera comprising local communications interface (22), means (24) of recognition and interrogation of local distribution data transmitters (12, 14, 16, 18, 19), using the interface, and memory (26) for recording images linked to data coming from local distribution transmitters. The camera can be used in a method of image enhancement with contextual data.

### FIELD OF THE INVENTION

The present invention relates to an image enhancement method using contextual data. Contextual data means data that provides some information on the environment or the context in which an image or a series of images were captured. While not being limited to such an application, the invention aims in particular to enhance images captured with general public type cameras. They are, for example, images captured by means of a digital camera, or by means of any other mobile communications equipment integrating a camera function, such as telephone cameras, camphones, or any other mobile terminal.

### BACKGROUND OF THE INVENTION

In the above mentioned field, there is a method enabling images to be enhanced with data relating to sounds, geographic data or even data reflecting a psychological state of the person who took the picture. Such a method is described, for example, in the document (1) whose reference is given at the end of the present description.

Implementation of the method entails multimedia equipment, i.e. equipment enabling various types of data to be captured and played back on various types of media. It can be, for example, hybrid portable equipment integrating a camera, a display device, a sound playback device, and an interactive interface for a user. Such equipment generally contains a common memory for data storage. The memory may contain image data captured with the camera, sound data from an MP3 type player, and any other data type captured on the interface by the user.

Other data is linked to the image data capable of being played back concomitantly with the display of the images. The additional data relate to sounds, music, or, more generally, to the picture-taking circumstances. Their play back aims to bring to the user's mind a broader emotional and perceptual context linked to the images. The image data are thus considered as enhanced.

The use of hybrid equipment for the simultaneous play back of images, music or other contextual elements of the picture-taking, suffers however from a number of limitations.

The most significant limitation is set by the hybrid equipment itself, and in particular by its intrinsic capacity to play back the picture-taking context. For example, if the equipment is only capable of playing back the music, the image enhancement remains limited to the musical context.

A second limitation, linked to the previous, relates to the fact that it is not possible to implement image enhancement with a camera more summary than the hybrid equipment.

### SUMMARY OF THE INVENTION

It is the object of the invention to propose a method of image enhancement that does not have the above-mentioned limitations.

It is an object of the invention in particular to propose an image enhancement method capable of being implemented using a simple camera, not having other multimedia resources.

It is also an object of the invention to propose an image enhancement method capable of integrating the user's human relational context, i.e. to identify the persons present during the picture-taking.

It is further an object of the invention to propose a simplified camera enabling the enhancement of captured images.

To achieve the above-mentioned objects, the invention has more specifically for object an automatic method of the enhancement of digital images using contextual data. The method comprises:
a) searching, in the camera's use environment, for local distribution data transmitters,
b) the establishment of communications with the transmitters present in the environment,
c) the reception of contextual data transmitted by the transmitters, and,
d) the lining of at least part of the contextual data to the image data captured in the use environment.

In the meaning of the present invention local distribution data transmitter means any device capable of transmitting data by radio or optical channels at a distance of some tens of meters. They are, for example, transmitters known by the commercial names “Bluetooth” or “Wi-Fi”, or even any transmitter operating according to a radio mode known as IEEE 802.11.x, IEEE 802.15.x, UWB, cellular or optical (IRDA), etc.

The invention method benefits from the fast multiplication of the number of domestic devices equipped with a local communications interface. This phenomenon results from the user desire to reduce wire cabling between devices that have to exchange information, and which are generally used in the same room. For example, various components of a personal computer, such as the keyboard, mouse and central processing unit can communicate in this mode. Other devices such as mobile phones, tuners, televisions, car radios, multimedia data drives can also have a local distribution transmitter.

Local distribution transmitters are capable of transmitting messages, whose form can vary according to the communications protocol planned by their programming. Nevertheless, for the same device type, the transmission contains an amount of data that is usual and specific to this device type.

As an illustration, the local distribution transmitter of a musical compact disc player generally transmits a message containing information about the piece of music that is being played. Additional information such as information relating to the music album, the author, the interpreter, etc. can be also be distributed. The local distribution transmitter of a mobile phone transmits identification data of the subscriber. This is, for example, his/her name or phone number. A television can be for example, equipped with a transmitter that distributes information about the current program and possibly a URL address to the site of the television channel where this program can be found later.

The gathering of data capable of enhancing images, which corresponds to steps a) to c) of the method, can take place at each picture-taking release. All or part of these steps can also take place advantageously, in a standby phase that precedes, and/or follows the release. The standby phase corresponds to an operating state of the camera during which a local communication interface of the camera is in operation without necessarily any picture-taking.

When the surrounding devices capable of supplying contextual data are not known, the step of searching for transmitters can comprise the detection of carrier waves capable of coming from local distribution data transmitters, the identification of the communication protocols used by the transmitters and the identification of the services available on the transmitters.

For example, the Bluetooth standard provides for a set of protocol components required to identify the available services. For example, the role of SDP (Service Discovery Protocol) is to discover the available services on the surrounding devices. Such services can include file transfer, fax, modem connection or data transfer services. In the same way the invention uses a service discovery protocol to identify the surrounding devices for which is planned, for example, a data transfer service, in this case of contextual data.

After the detection of a communication protocol and/or a service, communication can be established between the camera and a transmitter. More specifically, the camera can interrogate the transmitters. Interrogation takes place either according to a discovery protocol pre-established so as to select the transmitters respecting this protocol, or according to the protocol previously determined for each identified transmitter.

Image enhancement is preferably performed according to a mode similar to human mnestic and sensory mechanisms. People link sensory perceptions in their recollection either because they are concomitant, or because there is an emotional, cultural, or rational link between them. In the last case, concomitance can be imperfect.

In other words it is convenient to retain data for image enhancement, either because it gives information about an event temporarily close to the picture-taking moment, or because it gives information about an event capable of having a strong link with the captured image for the user.

It is particularly difficult to assess such a link. However, it is possible to assess, according to the type of contextual data transmitter, the emotional force that the context might have, and the mnestic persistence that it can arouse. For illustration, a user will probably better remember the music that he/she heard at the moment he/she took a photograph than the weather data that a local meteorological center could provide. Further, the repetition of contextual data leads to the assumption that the corresponding context had more strongly impressed the user.

Thus, according to a perfection of the invention, step d) of the method can comprise, for any contextual data received, the selection of a valid time slot, and the linking of the contextual data to the data of each image captured in the valid time slot.

Given the previous deliberations, the time slot can advantageously be fixed according to the type of device or equipment that the contextual data comes from. It can also be fixed according to the repetition frequency of the contextual data.

The linking of data to images can take several forms. Very simply contextual data can be linked to the image data as metadata. They can then be read and decoded at the same time as the image data.

According to another option, the link can be made using a pointer. The pointer is for example a coded graphic array, or barcode, capable of being read by a digital pen, or a scanner. In this case, step d) can comprise the recording of contextual data in a database and the linking to the contextual data of data coded as a graphic array capable of being read by a digital pen or by a scanner. The data of the coded array can be recorded with the image data. Furthermore, a combined printing of an image with the image data, and a coded graphic array with the coded graphic array data can be envisaged. Also the contextual data can be printed directly with the images, when they are capable of being converted into a legible format.

When the array is read and recognized by a digital pen, this issues an interrogation command of a remote database, and for data transfer to a suitable terminal of the user. In this case the command can be used to download sound, image or music data

The invention also relates to a camera comprising:

local communications interface,

means of recognition and interrogation of local distribution data transmitters, using the communications interface, and

memory for recording images linked to data coming from local distribution transmitters.

The camera can also comprise a local distribution data transmitter using the local communications interface, so as to transmit identification data to other cameras of the same type.

Other characteristics and advantages of the invention will appear in the following description, with reference to the figures in the appended drawings. This description is given purely as an illustration and is not limiting.

### BRIEF DESCRIPTION OF THE DRAWINGS

FIG. 1 is an illustration of a data exchange mode between equipment situated in a camera use environment, for implementing a method of image enhancement corresponding to the invention.

FIG. 2 is a flowchart corresponding to the possible implementation of an image enhancing method according to the invention.

FIG. 3 is a time-flow diagram illustrating a special image enhancing rule.

### DETAILED DESCRIPTION OF THE INVENTION

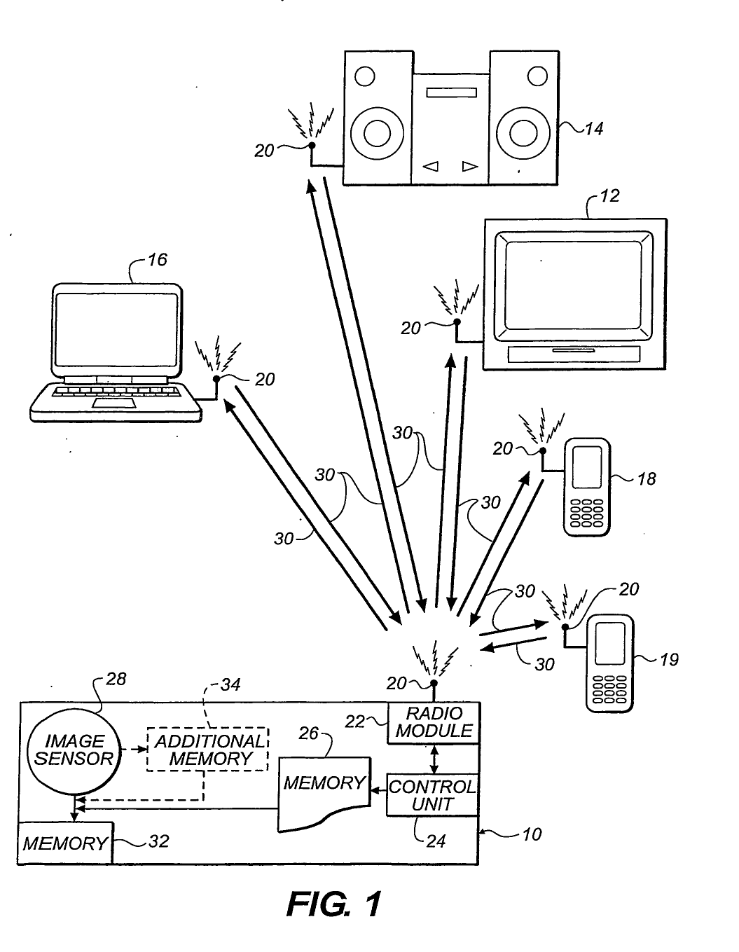

FIG. 1 represents a number of domestic equipment items situated in an environment involving a user provided with a camera 10 according to the invention.

Domestic equipment is mainly equipment for the playback or capture of sound, image or information. In this case it can be a television 12, stereo equipment 14, a personal computer 16 and mobile phones 18, 19. Other equipment could also be present in the environment.

The above-mentioned domestic equipment, as well as the camera 10 are each equipped with a local communications interface. Interfaces are symbolically represented as small antennas 20.

The use environment of the camera is defined by the local character of the transmission and reception capacities of the communications interfaces. In other words the environment is limited to the transmission range. For known local communication interfaces, “Bluetooth” or “WiFi” type, the range is, as previously mentioned, some tens of meters. It is sufficient to cover a room containing the user. The use environment modifies over time, because of the user's movements with the camera.

It should also be stated that the various equipment items of FIG. 1 are not represented according to a uniform scale, for simple reasons of clarity of the figure.

Each item of equipment is capable of supplying an amount of data through its communications interface 20.

For example, the television is capable of transmitting information relating to a television program that is being broadcast, or a uniform resource locator address (URL). This is, for example, the address of an Internet site from which program can be downloaded, or a site where additional information about the television program can be obtained, etc.

Similarly, and already mentioned in the description of the invention, the stereo equipment can transmit information relating to a replayed piece of music, and the mobile phone can transmit an identification of its main user. Thus each equipment item is capable of locally distributing information about the visual, sound or information context that it generates. This information is again called “contextual data”. The simplest contextual data that is generally transmitted, is the identification of the nature of the transmitting equipment. In other words it is possible to know if the contextual data comes from the television, mobile phone or from some other item of equipment.

All the image, audio, video and more generally sensory signals captured by all the equipment present and communicating in the environment during the use of the camera, constitute sources of contextual data.

The camera 10 comprises, like the other equipment, an antenna for local distribution and a local communications interface. This is formed by a module 22 of radio transmission-reception, linked to the antenna 20.

The local communications interface is run by a control unit 24 programmed to recognize local distribution data transmitters. The unit 24 is programmed in particular to detect carrier waves, recognize communication protocols and establish communication links with the identified transmitters. “Transmitter” here means any device in the environment capable of supplying contextual data.

The communication links between the camera 10 and the transmitters are symbolized by double arrows 30, to indicate a communication mode according to a question/answer protocol. The communication links can be established successively and periodically, or concomitantly. Other communication protocols, such as protocols for blind data distribution by transmitters can be also implemented.

The communication established between the camera and the local distribution transmitters enables information to be gathered as contextual data. As previously mentioned, this can involve textual data, a uniform resource locator address (URL) or, even multimedia data that can be used directly in a suitable device.

These data are processed and temporarily saved in a memory 26. They can be extracted from it to be linked to image data coming from the camera's image sensor 28. While not being represented in great detail on the figure, an image processing unit can be linked to the sensor 28 to supply the image data. The image data and the data extracted from the memory 26 are linked and stored in a memory 32 for the temporary storage of enhanced images. On FIG. 1 the memory 26 containing image data only and the memory 32 containing the enhanced images are represented separately. This does not exclude the use of a single memory for storing the raw images and enhanced images at the same time. Furthermore, an additional memory 34 can be planned for the temporary storage of as yet non-enhanced images. Such a memory in particular enables images to be stored for a time necessary to gather contextual data, or finish the gathering.

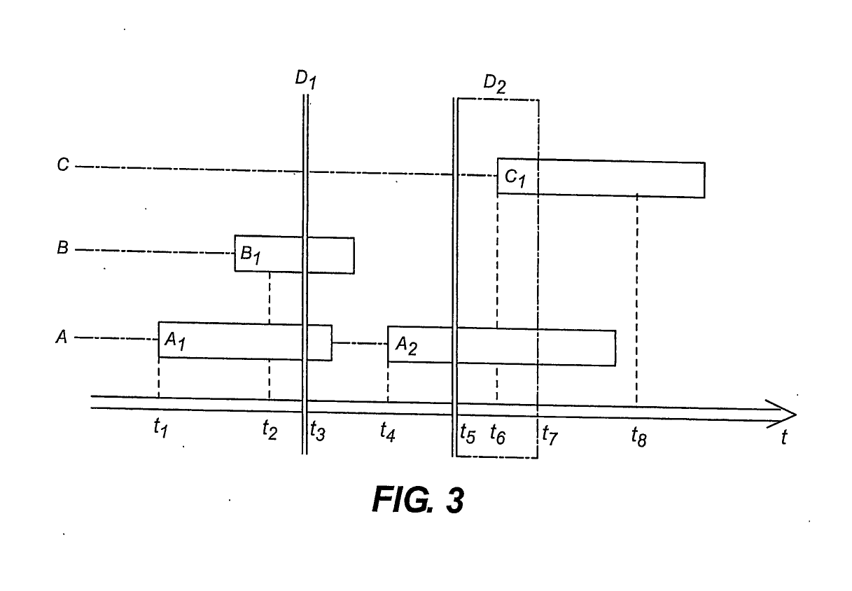

The management of contextual data and image data will be described in more detail hereafter, with reference to FIG. 3.

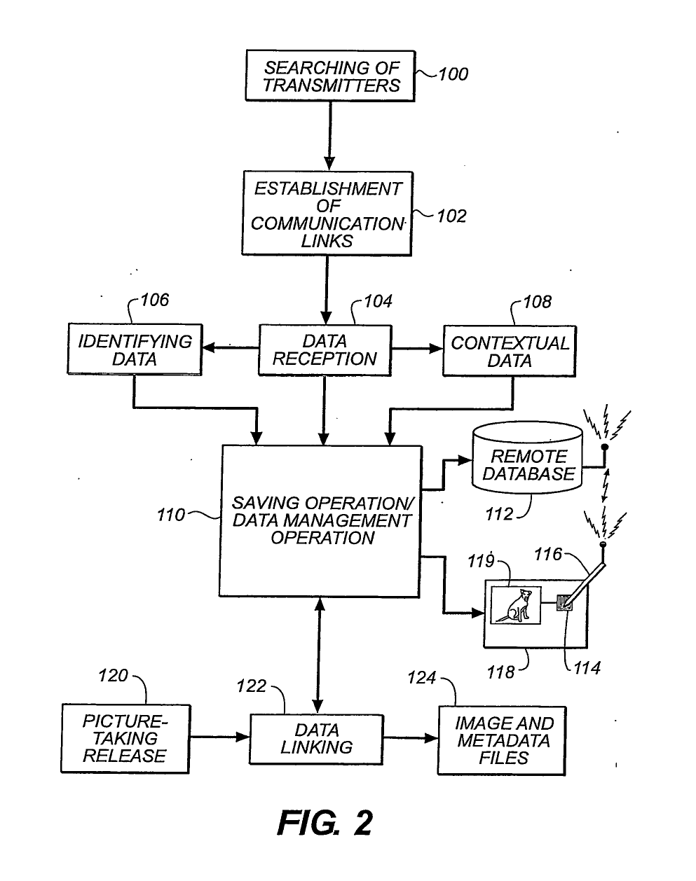

FIG. 2, described below, shows the main steps of the image enhancement method. Some of these steps were previously mentioned with reference to FIG. 1. They are thus simply recalled.

A first operation, shown by reference 100 is searching, in the camera's use environment, for local distribution data transmitters. This operation includes the search for carrier waves coming from possible transmitters, and the identification of the communication mode used by the transmitters found in the environment. This amounts to establishing the communication protocol used. The protocol is identified from signatures, i.e. by the recognition of characteristic information packets. It can be also determined by trying to establish a communication according to several programmed discovery protocols. The camera can in particular determine the protocol to be used by trying to establish a communication according to, for example, a Bluetooth type protocol or a WiFi type protocol.

The search for local distribution data transmitters takes place in a camera standby mode, i.e. independently of picture-taking. By moving about during the day, the user successively moves the camera into or out of the radio coverage area of various transmitters. The camera's use environment is thus liable to change.

A second step 102 comprises the establishment of a communication link and the interrogation of the previously identified transmitters. The communication link can be established for a first time with each new transmitter identification in the camera's use environment. The transmitter can then be interrogated periodically, for as long as it is in the camera's use environment. The camera can also be put in a standby mode in which it simply gathers data spontaneously transmitted by the transmitters of its environment. Finally, the camera can be designed to program the transmitters of its environment by the transmission of a suitable piece of program code. The transmitted program code causes, for example, the sending by the environment's transmitters of contextual data for each change of their specific data or at preset time intervals. Specific data are data that the transmitters transmit or receive.

The reception of data transmitted by the various transmitters is shown on FIG. 2 by the reference 104. Among these data, one can find on the one hand, data 106 identifying the transmitting equipment type, and on the other hand, contextual data 108 transmitted by these transmitters. The data identifying the transmitter type indicate for example whether the transmitter is a television, telephone, computer, compact-disc player or some other equipment. These data can also be used as contextual data in the rest of the method.

The transmitter identification data and the contextual data are saved and used to check the image enhancement. Reference 110 indicates a saving operation and also an available data management operation. It will be described in more detail with reference to FIG. 3.

Returning to FIG. 2, the block 120 indicates a picture-taking release. According to the type of camera used, this can involve a single picture-taking release or a picture-taking sequence release. The release causes the capture of a set of image data relating to one or more images. These image data can be formatted and/or temporarily stored. They are, for example, put into a digital file.

Following these operations the linking 122 of the image data and contextual data takes place. The linking can be direct, for example, by registering the contextual data as metadata in the files 124 moreover containing the image data.

According to another option, the linking of contextual data to the image data can be indirect, by simply linking a useful pointer to the image data to find the contextual data in a remote database 112. The pointer consists for example of coded array data 114 capable of being read by means of a digital pen 116. Following the reading of the coded array, a reading message corresponding to the coded array is transmitted from the digital pen to a server or computer. This houses a database containing the image's contextual data. The contextual data identified from the read coded array can then be transmitted to the user. When the contextual data are themselves addresses or pointers, the other data towards which the contextual data point can be transmitted or downloaded. This can be multimedia data capable of being reproduced at the same time as the images, by means of a suitable player. FIG. 2 illustrates the simultaneous printing on a support 118 of a photograph 119 and a coded array 114. The support 118 is represented with a single photograph. It could also contain several photos, in the style of an index strip on which each photograph would be linked to its own coded array. The coded array data and the image data can be linked and saved in order to be printed out later.

FIG. 3 illustrates a management option for data coming from local distribution transmitters. For reasons of simplification only three local distribution transmitters are considered. They are marked with letters A, B and C.

The instants of contextual data reception are marked on a time scale indicated with the letter t. Instants t₁, t₂, t₄ and t₆ correspond to the reception of messages A₁, B₁, A₂, and C₁. The received messages are symbolized by rectangles whose length is proportional to the duration of validity. Here duration of validity means the time slot during which contextual data may be held for image enhancement. This does not exclude longer storage of the contextual data, possibly enabling them to be made available to the user for custom enhancement.

Letters D₁ and D₂ indicate respectively picture-taking releases at instant t₃ and t₅.

It can be seen on FIG. 3 that the validity durations are not identical for the various devices A, B, and C. Data giving information on the transmitter type, in this case data identified with the reference 108 on FIG. 2, is used to provide the validity duration of the each device's data.

Another parameter that can be used to provide the validity duration is the frequency with which an equipment item is used or the frequency with which it transmits similar contextual data.

This is illustrated for the equipment item A. A first contextual data A₁ is stored with a first validity duration. A second data A₂, more or less identical, while coming from the same equipment item has longer validity duration.

This enables the fact to be taken into account that the repetition of a phenomenon or an event has the effect of more strongly marking the user's recollection. For example, if the equipment item A is sound playback equipment that transmits a piece of music identified by the contextual data A₁. The retransmission of the same piece of music, identified by the data A₂, will result in longer storage of the data A₂ for image enhancement purposes.

The release D₁ takes place at the instant t₃ when data A₁ and B₁ are valid. The image captured at the instant t₃ is thus enhanced with data A₁ and B₁.

The contextual data A₁, A₂ and C₁ are capable of being used for image enhancement, from the moment they are received, i.e. from instants t₁, t₄ and t₆. Such contextual data management respects a time causation rule. Respecting a time causation rule demonstrates the fact that the user more easily links in his/her recollection concomitant perceptions or perceptions that he/she created an intellectual link for. For example, the user will more easily link an event experienced with music that he/she hears or that he/she hears briefly, than with music that he/she heard a long time before event occurred. The wedding march heard at a marriage is a typical illustration.

For certain equipment however, there is an interest in breaking the time causation rule. This is the case for equipment such as the mobile phones 18, 19 of FIG. 1. They provide contextual data of the user's social environment during picture-taking. The phone numbers or the subscribers names using them indeed enable the user to recall which people were around when a photo was taken. However, it is quite likely that these people were already together with the user before they made use of their telephones or before the telephones were powered up. In other words, the reception of contextual data is not necessarily concomitant with the perception of the user whose images are required to be enhanced.

It can be seen that the data B₁, of FIG. 3 is active after the instant t₂ of its reception, but also before its reception. This paradoxical breaking of the time causation rule is possible provided that the image data and the contextual data are not linked at the picture-taking moment, but later. An illustration of this is given by the release D₂. The release D₂ at the instant t₅ is used to enhance the image captured not only with contextual data valid at the instant t₅, but also with contextual data valid in a time window. The time window, between instants t₅ and t₇, is shown by a dot and dash line. The image captured at the instant t₅ is thus enhanced by the contextual data A₂ that was valid, and the contextual data C₁, valid from instant t₆ only. The instant t₆ is indeed included in the time window. It can be easily understood that the linking of the image and the contextual data cannot take place at the picture-taking instant, because at this instant data C₁ was not available. It can take place with a preset delay, which in this case is greater than the time interval t₇-t₆. Everything happens as if the data C₁ was already valid at the instant t₅.

### REFERENCE DOCUMENT

(1) EP-A-1,301,023

1. A method of enhancing digital images captured by a camera, with contextual data, comprising:
a) searching (100), in the camera's use environment, for local distribution data transmitters,
b) establishing (102) communication with the transmitters present in the communications environment,
c) receiving (104) contextual data transmitted by the transmitters, and,
d) linking (122) at least part of the contextual data to the image data relating to the images captured in said use environment.

2. A method according to claim 1, wherein the execution of step d) follows a picture-taking release, for image data capture.

3. A method according to claim 1, wherein at least one of the steps a), b) and c) takes place in a standby phase preceding the release.

4. A method according to claim 1, wherein at least one of the steps a), b) and c) takes place in a standby phase following the release.

5. A method according to claim 1, wherein step d) is concomitant with the picture-taking release.

6. A method according to claim 1, wherein step d) is delayed compared with the picture-taking release.

7. A method according to claim 1, wherein step a) comprises the detection of carrier waves capable of coming from local distribution data transmitters, and the identification of the communication protocols used in said transmitters.

8. A method according to claim 1, wherein step b) comprises the interrogation of the local distribution data transmitters.

9. A method according to claim 1, wherein step b) comprises the sending of a program code to the environment's transmitters, to cause the sending by these transmitters of contextual data.

10. A method according to claim 1, wherein step d) comprises, for any contextual data received, the selection of a valid time slot, and the linking of the contextual data to the data of each image captured in the valid time slot.

11. A method according to claim 10, wherein the time slot is set according to an equipment type from which the contextual data comes.

12. A method according to claim 1, wherein step d) comprises the saving of the contextual data as metadata linked to the image data.

13. A method according to claim 1, wherein step d) comprises the linking to the image data of a pointer pointing to the contextual data stored in a database (112).

14. A method according to claim 13, wherein step d) comprises the saving of the contextual data in a database (112), and the ling to the contextual data of a coded graphic array (114), that can be used as a pointer by means of a digital pen (116).

15. A method according to claim 14, also comprising the saving of the coded array data with the image data.

16. A method according to claim 14, also comprising the combined printing of an image (119) from the image data and a coded graphic array (114) from the coded graphic array data.

17. A method according to claim 1, wherein the contextual data contain at least one uniform resource locator address (URL).

18. A method according to claim 1, also comprising a step of reading the image data and contextual data, searching for multimedia data by using the contextual data as a pointer and the simultaneous reproduction of multimedia content corresponding to the multimedia data and the image corresponding to the image data.

19. A camera comprising:
local communications interface (22),
means (24) of recognition and interrogation of local distribution data transmitters (12, 14, 16, 18, 19), using the interface, and
memory (26) for recording images linked to data coming from local distribution transmitters.

20. A camera according to claim 19, comprising a local distribution data transmitter using the local communications interface, and capable of transmitting identification data to other cameras of the same type.
